(19) United States
(12) Patent Application Publication
(10) Pub. No.: US 2026/0078836 A1
(43) Pub. Date: Mar. 19, 2026

(54) VALVE DEVICE, VIBRATION DAMPER, MOTOR VEHICLE AND METHOD FOR PRODUCING A VALVE DEVICE

(71) Applicants: thyssenkrupp Bilstein GmbH, Ennepetal (DE); thyssenkrupp AG, Essen (DE)

(72) Inventor: Christoph SCHMIDT, Bonn (DE)

(73) Assignees: thyssenkrupp Bilstein GmbH, Ennepetal (DE); thyssenkrupp AG, Essen (DE)

(21) Appl. No.: 19/327,917

(22) Filed: Sep. 12, 2025

(30) Foreign Application Priority Data
Sep. 13, 2024 (DE) 10 2024 126 515.9

(51) Int. Cl. F16K 31/06; F16F 9/34; F16K 27/04

(52) U.S. Cl. CPC F16K 31/0675; F16F 9/34; F16K 27/048; F16F 2222/12; F16F 2226/04; F16F 2230/24; F16K 2200/305

(57) ABSTRACT

A valve device for a vibration damper comprises at least one valve drive which includes at least one coil, at least one ferromagnetic armature which can be actuated by the coil, and at least one housing part, in particular a pole tube, wherein the armature and the housing part have a common longitudinal axis, and the armature is arranged axially displaceably in the housing part, wherein the armature is adapted to interact with a valve slide of the valve device for throughflow control and/or for pressure control of the damper fluid. The valve device comprises at least one preloading element which is fastened in and/or to the housing part, and at least one spring element which is supported on the preloading element and interacts with the armature in such a way that, upon actuation of the armature, the spring element applies a spring force counter to a displacement direction of the armature or in a displacement direction of the armature.

### CROSS REFERENCE TO RELATED APPLICATION

This application is a U.S. Non-Provisional that claims priority to German Patent Application No. DE 10 2024 126 515.9, filed Sep. 13, 2024, the entire content of which is incorporated herein by reference.

### FIELD

The present disclosure relates to a valve device, a vibration damper, a motor vehicle and a method for producing a valve device.

### BACKGROUND

Vibration dampers are commonly used for motor vehicles and in the industrial sector, in order to ensure safe and comfortable driving behaviour of a vehicle in different driving conditions on account of irregularities such as, for example, bumps, potholes or other anomalies of the road surface. Furthermore, vibration dampers also serve to stabilize vehicles when travelling under relatively extreme conditions such as, for example, when travelling off-road.

In order to increase the driving comfort and the driving safety, the damping characteristic of the vibration damper is normally adjustable. For example, this takes place via a solenoid valve, via which the flow of a damper fluid within the vibration damper is adjustable.

Different influencing variables such as production-related tolerances of the valve and damper components can impair the electromagnetic switching function of an adjustable damper valve. Damper valves are often adjustable in order to compensate for influencing variables of this type. DE 10 2015 006 063 A1 has disclosed, for example, a damper valve with an adjustable electromagnet. It is a disadvantage, however, that only some of the possible influencing variables on the switching function of the damper valve can be compensated for by the adjustable electromagnet.

Thus a need exists of specifying a valve device for a vibration damper, which is adjustable in such a way that an electromagnetic switching function of the valve device is improved.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a longitudinal section through a vibration damper with a valve device in accordance with one preferred exemplary embodiment according to the invention.

FIG. 2 shows a longitudinal section through the vibration damper according to FIG. 1 in the region of the valve device.

FIG. 3 shows a detail from FIG. 2 in the region of a preloading element and spring element of the valve device according to FIG. 1.

FIG. 4 shows a longitudinal section through a vibration damper with two valve devices in accordance with one preferred exemplary embodiment according to the invention.

FIG. 5 shows a longitudinal section through one of the two valve devices according to FIG. 4.

FIG. 6a shows a detail from FIG. 5 in the region of a preloading element and spring element of the valve device according to FIG. 5.

FIG. 6b shows a detail in the region of a preloading element and spring element of a valve device in accordance with a further preferred exemplary embodiment.

FIG. 6c shows a detail in the region of a preloading element and spring element of a valve device in accordance with a further preferred exemplary embodiment according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include a vibration damper, a motor vehicle and a method for producing a valve device.

Specifically, some embodiments include a valve device for a vibration damper with at least one valve drive which comprises at least one coil, at least one ferromagnetic armature which can be actuated by the coil, and at least one housing part, in particular a pole tube. The armature and the housing part have a common longitudinal axis, and the armature is arranged axially displaceably in the housing part. The armature is adapted to interact with a valve slide of the valve device for throughflow control and/or for pressure control of the damper fluid. Furthermore, the valve device comprises at least one preloading element which is fastened in and/or to the housing part, and at least one spring element which is supported on the preloading element and interacts with the armature in such a way that, upon actuation of the armature, the spring element applies a spring force counter to a displacement direction of the armature or, upon actuation of the armature, the spring element applies a spring force in a displacement direction, in the direction of a displacement movement, of the armature.

The invention has the substantial advantage that, via the preloading action of the preloading element, the spring element firstly introduces into the armature a spring force which, upon actuation, in particular in use, counteracts a magnetic force which is introduced by the coil into the armature. In other words, the spring force which is introduced into the armature acts counter to a displacement movement of the armature, which takes place by energization of the coil and the introduction of a magnetic force into the armature. Or, put another way, the spring element interacts with the armature in such a way that, upon its actuation by the coil, in particular, upon performance of a displacement movement, the armature is spring-preloaded counter to its displacement direction.

Secondly, via the preloading effect of the preloading element, the spring element can introduce into the armature a spring force which, upon actuation, in particular in use, acts with a magnetic force which is introduced by the coil into the armature. In other words, that spring force of the spring element which is introduced into the armature acts in the direction of a displacement movement, that is to say in a displacement direction, of the armature, which displacement movement takes place by energization of the coil and the introduction of a magnetic force into the armature. Or, put another way, the spring element interacts with the armature in such a way that, upon its actuation by the coil, in particular upon performance of a displacement movement, the armature is moved or can be moved in its displacement direction by the spring force of the spring element in addition to the magnetic force.

Whether the spring element introduces a spring force counter to the displacement direction of the armature or in the direction of the displacement movement, in particular in the displacement direction, of the armature is dependent on the type of interaction of the spring element with the armature. This is, for example, contingent on the position and arrangement of the spring element and/or preloading element.

Within the context of the invention, the displacement movement of the armature takes place parallel to the longitudinal axis. In other words, the displacement movement of the armature takes place along the longitudinal axis. The armature can be configured in one part or in multiple parts. The armature can have at least one part which is stationary in the coil and one part, in particular an armature rod, which is displaceable along the longitudinal direction. Within the context of the invention, the spring element interacts with the displaceable part of the armature, in particular the armature rod.

The valve device according to the invention can therefore be adjusted or set in such a way that an optimum electromagnetic switching function of the valve device is realised in use. The valve device can be configured in such a way that it is open or closed in a currentless state (rest state). A valve device which is open in the currentless state is called an NO valve device, in particular are “normally open” valve. The valve device which is closed in the currentless state is called an NC valve device, in particular a “normally closed” valve.

In order to carry out an adjustment operation of a valve device which is open in the currentless state, the preloading element preloads the spring element against the armature, in particular counter to the armature displacement movement. To this end, the preloading element is fastened in or to the housing part in such a way that the spring force of the spring element is adapted to the magnetic force of the valve drive, as a result of which the electromagnetic switching function of the valve device is optimised. This adaptation takes place by way of the (fixed) setting of the preload of the spring element which takes place during fitting, in particular the assembly of the valve device.

In order to carry out an adjustment operation of the valve device which is closed in the currentless state, the preloading element preloads the spring element against the armature such that the spring force of the spring element acts in the direction of the armature displacement movement. To this end, the preloading element is fastened in or to the housing part in such a way that the spring force of the spring element is adapted to the magnetic force of the valve drive, as a result of which the switching function of the valve device is optimized. This adaptation takes place by way of the (fixed) setting of the preload of the spring element which takes place during fitting, in particular the assembly of the valve device. In the case of this valve device, the magnetic force and the spring force of the spring element preferably acts in the same direction counter to a defined, in particular increased, spring force of at least one closing spring which serves to close the valve device in the currentless state.

By way of the adjustment of the valve device, different influencing variables on the switching function of the valve device such as manufacturing tolerances of the valve components and/or influences from the fitting of the valve device such as, for example, positional inaccuracies of the valve components can be compensated for simply. The switching function of the valve device in use is improved by the compensation of these influencing variables. In particular, the degree of uniformity or likeness of a multiplicity of produced valve devices is improved.

The preloading element preferably preloads the spring element against the armature in such a way that, at a low current strength with which the coil is energized, the spring force is substantially equal to the magnetic force which is introduced by the magnetic field of the coil. At an increased current strength, the spring element serves to adjust the forces to a defined force level. In a maximum working position of the armature, the magnetic force can be (much) greater than the spring force of the spring element. In general, the magnetic force can be variable in the maximum working position of the armature depending on the characteristic. In the maximum working position, the armature is completely extended. The maximum working position preferably corresponds to the maximum stroke of the armature. The maximum working position is preferably determined by the interaction of the armature with the valve slide.

In the installed state, preferably in the case of a valve device which is open in the currentless state, the spring element preloads the armature in such a way that, if it is driven by the magnetic force of the coil in use, it is moved counter to the spring force of the spring element, in order to actuate the valve slide for throughflow control or for pressure control. In the magnetic force-free state, the spring element can move the armature counter to its actuating direction. The spring element therefore serves not only for adjusting the magnetic force in use, but rather can also serve to restore the armature into its starting position (rest state).

In the installed state, preferably in the case of a valve device which is closed in the currentless state, the spring element preloads the armature in such a way that, if it is driven in use by the magnetic force of the coil, it is moved with the spring force of the spring element, in order to actuate the valve slide for throughflow control or for pressure control.

The spring force of the spring element is preferably adapted during the adjustment operation to the magnetic force of the coil in such a way that optimum actuation of the valve slide and therefore improved throughflow control or pressure control takes place. As a result, a best possible electromagnetic switching function of the valve device is achieved in use. Manufacturing tolerances or positional inaccuracies of the valve components can be compensated by this adaptation of the spring and magnetic force in such a way that the armature exerts a constant force on the valve slide in a defined driving situation, and therefore the damping force, required by a driving situation, of the vibration damper can be set in line with the current.

The preloading element is preferably arranged in or on the housing part fixedly, in particular fixedly in terms of displacement. A subsequent adaptation of the spring preload is not provided here. To this end, the preloading element can be connected non-releasably to the housing part.

The preloading element is preferably configured in such a way that the spring element is supported on the preloading element in the installed state. The preloading element is preferably positioned in the axial direction in relation to the armature in such a way that there is an offset in the longitudinal axial direction between a spring element connection to the preloading element and a spring element connection to the armature, in particular the armature rod. As a result, the spring preload of the armature is realised counter to its extension direction, in particular actuating direction.

The spring element preferably lies against the preloading element in order to preloading the armature counter to its displacement movement upon actuation. The spring element can lie loosely on the preloading element or can be fastened so as to lie on the preloading element. The spring element is preferably connected directly to the preloading element. As an alternative, it is possible that at least one intermediate layer is arranged between the spring element and the preloading element. In other words, as an alternative, the spring element can be connected indirectly to the preloading element. In addition or as an alternative, the spring element can be connected to the preloading element in a positively locking and/or integrally joined manner. For example, the spring element can engage at least in sections into the preloading element for fastening purposes. Further alternative fastening types are possible.

The spring element is preferably connected directly to the armature, in order to introduce a spring force into the latter. To this end, the spring element can be connected to the armature in such a way that the spring element lies at least in sections on it, in particular on a shoulder of the armature. The spring element can lie loosely on the armature. The spring element can therefore be connected to the armature in a non-positive manner. As an alternative, it is possible that the spring element is connected fixedly to the armature. To this end, the spring element can be connected to the armature in a positively locking and/or integrally joined manner. The spring element can engage at least partially into the armature, in order to form a positively locking connection. Further alternative fastening types are possible.

The housing part of the valve drive is preferably configured as a pole tube. As described, the preloading element is fastened in/to the housing part. The housing part therefore supports the preloading element. The housing part preferably receives the preloading element. In addition, the housing part can receive, in particular support, the coil.

The valve device is preferably a solenoid valve. The valve device can comprise a directional valve, in the case of which the valve slide serves to control at least one throughflow opening for the damper fluid. As an alternative, the valve device can comprise a pressure limiting valve, in the case of which the valve slide can be actuated in a manner dependent on the fluid pressure.

The valve device is preferably used in or on a vibration damper as a damper valve for setting the damping force. It is possible that the valve device is used as a bypass valve or a pilot valve. The valve device is not restricted to these uses, however.

In one preferred embodiment, the preloading element is configured as a ring. The preloading element can be called a preloading ring. The ring is preferably configured with one step, wherein its (first) bearing surface for the spring element preferably forms the single step. The ring preferably has a rectangular cross section. The ring is preferably arranged coaxially with respect to the armature. The ring preferably runs completely around the armature and provides the spring element in the circumferential direction at least in sections with a connecting region, in particular a first bearing surface. The ring has the advantage that firstly space-saving mounting in or on the housing part is enabled and secondly the ring is inexpensive.

The ring can be configured as an open ring or as a part ring. The ring can be configured to be circular or with a contour which differs from a circular contour, in particular as a polygonal ring. Other ring shapes which are not mentioned are possible.

In addition or as an alternative, the spring element preferably comprises at least one flat spring, in particular a flat shaped spring. In other words, the spring element is preferably configured as a disc spring. Or, put another way, the spring element is preferably configured as a disc-shaped spring. The spring element is preferably arranged coaxially with the armature. The spring element is preferably configured as a circular disc. The spring element can be of star-shaped configuration. In other words, the spring element can be configured as a star disc. An angular outer shape of the spring element is possible. The spring element preferably encloses the armature completely. As an alternative, it is possible that the spring element can enclose the armature at least in sections. The spring element extends transversely with respect to the longitudinal axis between the armature and the preloading element. A clearance, in particular an annular space which is provided around the armature, is preferably formed between the armature and the preloading element, into which clearance the spring element can deform at least in sections in the case of a displacement movement of the armature.

It is advantageous here that the use of spiral springs or variable coil windings is dispensed with. An adjustment of the magnetic force by a spiral spring is disadvantageous, since the pitch of the magnetic force cannot be set on account of the linearity of the spiral spring. This is possible by way of the flat spring, however. In addition, spiral springs are disadvantageous with regard to the required installation space, and have increased costs in comparison with flat springs. In the case of the use of spiral springs, measuring or sorting is often necessary in advance. This is omitted in the case of flat springs.

In the case of a further preferred embodiment, the housing part has at least one recess, in which the preloading element and the spring element are received, wherein the preloading element is connected fixedly to a side wall of the recess. The preloading element and the spring element are preferably received completely in the recess. The spring element is preferably arranged in the axial direction between the preloading element and a bottom of the recess. In other words, the housing part comprises a recess, into which the preloading element is inserted so as to be seated fixedly. The recess is delimited transversely with respect to the longitudinal axis by its side wall, with which the preloading element preferably interacts in order to form a fixed seat. This embodiment is advantageous, since the preloading and spring element are integrated into the recess. This is space-saving and contributes to a compact overall design of the valve device.

The preloading element is preferably pressed into the recess. In other words, there is a press-fit between the preloading element and the side wall of the recess. The preloading element can therefore be connected to the side wall of the recess in a non-positive manner. The preloading force, that is to say the spring force which preloads the armature, is determined via pressing in of the preloading element in the axial direction. The further the preloading element is inserted in the axial direction into the recess, the higher the spring force, with which the armature is preloaded counter to or in its displacement direction, in particular actuating direction or extension direction. As a result, the required spring force can be preset in a simple way during the assembly of the valve device.

In addition or as an alternative, the preloading element can be connected to the side wall of the recess in an integrally joined manner, in particular by welding or adhesive bonding, and/or in a positively locking manner, by positively locking engagement. The preloading force is set as described above.

In the case of a further preferred embodiment, the armature has at least one shoulder with a step which faces away from a centre of the housing part in the longitudinal axial direction, wherein the spring element lies at least partially on the step. In other words, the spring element is preferably in (in particular, direct) contact with the step of the shoulder, in order to introduce a spring force into the armature. The shoulder is preferably configured on the circumference of the armature. The shoulder preferably runs around the armature completely. The armature can be cylindrical. The armature is preferably a rod, in particular an armature rod. The shoulder can be produced simply, which contributes to the reduction in costs. In addition, a simple connection to the spring element is enabled by the shoulder.

In addition or as an alternative, the spring element can engage at least partially into the shoulder, in particular loosely.

The preloading element preferably has at least one first bearing surface which faces a centre of the housing part in the longitudinal axial direction and forms a first abutment for the spring element. The first bearing surface preferably faces the bottom of the recess. The first bearing surface can run around the armature in a manner which is continuous or split in sections. A pressing force of the preloading element is transmitted to the spring element via the first abutment, wherein the level of the pressing force determines the preload, by way of which the spring element preloads the armature. It is advantageous if the spring element lies directly on the first bearing surface. It can be advantageous, furthermore, if the spring element lies on the first bearing surface loosely, in particular releasably. An indirect contact via an intermediate insert is possible. The preloading element has a geometry which is as simple as possible and is inexpensive to produce.

It is advantageous if the preloading element has a second bearing surface for the spring element, which adjoins the first bearing surface radially on the inside and is offset in the longitudinal axial direction from the first bearing surface in order to form the step. The second bearing surface is preferably offset from the first bearing surface in the actuating direction, in particular extension direction, of the armature. In other words, the preloading element is of two-step configuration. The preloading element preferably has a greater diameter on the first bearing surface than on the second bearing surface. In other words, the preloading element has a first and a second rolling diameter for the spring element as a result of the two-step shape.

The first rolling diameter is defined by the first bearing surface, and the second rolling diameter is defined by the second bearing surface. As a result of the two-step nature, the preloading element preferably comprises two edges which are offset from one another, in particular in relation to the longitudinal axis in the radial direction and in the axial direction, with which the spring element comes into contact sequentially in the case of movement of the armature in the direction of the valve slide, in particular in the case of extension. In the case of an actuation of the armature, in which the coil introduces a magnetic force into the armature and, as a result, moves the latter in the actuating direction, in particular extension direction, the spring element is first of all in contact with the first bearing surface and, in a manner dependent on the armature position, is subsequently in contact with the second bearing surface which forms a second abutment for the spring element. Or, put another way, the spring element is first of all deformed on the first edge (first rolling diameter) and secondly on the second edge (second rolling diameter) in the displacement direction of the armature in such a way that the spring element introduces different spring forces into the armature. As a result, a stroke-dependent stiffness of the spring element can be realised. This is advantageous in the case of a failsafe solution, since one of conventionally two necessary springs is dispensed with. Furthermore, it is advantageous that variable pre-opening of the valve device can be realised, depending on energization of the coil.

In the case of one preferred embodiment, the spring element has at least one supporting portion for supporting on the preloading element, which supporting portion is arranged radially on the outside in relation to the longitudinal axis, wherein the supporting portion is preferably in contact with the first bearing surface. The supporting portion can comprise a circular ring surface for bearing on the first bearing surface of the preloading element which is configured radially on the outside. The circular ring surface can be continuous in the circumferential direction. As an alternative, the circular ring surface can be split in sections. In addition or as an alternative, the supporting portion can have at least one projection which lies on the first bearing surface. It is advantageous if the supporting portion has a plurality of projections distributed in the circumferential direction for bearing on the first bearing surface.

The spring element preferably has at least one coupling portion which is arranged radially on the inside in relation to the longitudinal axis and is connected to the armature for the introduction of a spring force. The coupling portion preferably lies on the step of the shoulder of the armature. Like the supporting portion, the coupling portion can have a circular ring surface for bearing on the step. The coupling portion serves to introduce a spring force into the armature, in order to realise a spring preload counter to the displacement movement by the magnetic force or in the displacement direction of the armature.

The spring element preferably has at least one connecting portion which connects the coupling portion to the supporting portion, wherein the connecting portion has at least one web, in particular a plurality of webs, which extends/extend in the radial direction between the coupling portion and the supporting portion. The connecting portion preferably comprises a plurality of apertures which are configured between (the) webs. It is advantageous here that there is a possibility via the connecting portion to preset the stiffness of the spring element in a requirement-specific manner. This can take place, for example, by variation of the web widths.

In the case of one embodiment, the spring element comprises at least one armature guide which guides the armature along the longitudinal axis, wherein the armature guide is preferably part of the coupling portion. This has the advantage that a bearing bush for guiding the armature can be dispensed with.

In the case of one embodiment of the valve device which is closed, in particular, in the currentless state, the valve device has at least one closing spring, in particular an NC spring, which moves the armature and/or a/the valve slide of the valve device in a currentless state of the coil into a closed position, wherein, in an energized state of the coil, the magnetic force and the spring force of the spring element act counter to a closing spring force of the closing spring. The closing spring can be supported on the valve housing, in order to introduce the closing spring force into the armature. The closing spring can be arranged on the armature on a side of the armature which lies opposite the spring element.

In the case of one preferred embodiment, the valve device (open in the currentless state) has at least two valve seats and at least one failsafe spring element and/or at least one locking element, wherein the failsafe spring element or the locking element is arranged in the longitudinal axial direction between the valve slide and the preloading element. In normal operation, the valve slide preferably interacts with the first valve seat. In failsafe operation, the failsafe spring element or the locking element interacts with the second valve seat which is configured on the valve slide.

In normal operation, the coil is energized, with the result that it introduces a magnetic force into the armature which in turn moves the valve slide against the first valve seat. In a manner dependent on a damper fluid pressure which prevails on the valve slide, the valve slide and thus also the armature are moved counter to its actuating direction, that is to say in the retraction direction. As a result, a throughflow cross-section for the damper fluid is set between the first valve seat and the valve slide in a manner dependent on the fluid pressure.

In failsafe operation, the coil is currentless. This can be brought about deliberately or as a result of a defect, that is to say in an undesired manner. In failsafe operation, the armature is free from magnetic force. In this state, the armature is situated in its retracted position, in which no interaction with the valve slide is possible. In the case of a first variant, the valve slide interacts via the valve seat with the failsafe spring element in failsafe operation. In a manner dependent on a damper fluid pressure which prevails on the failsafe spring element, the failsafe spring element is deformed at least in sections, in particular resiliently. As a result, a throughflow cross section for the damper fluid is set between the failsafe spring element and the second valve seat of the valve slide in a manner dependent on the fluid pressure. In this way, targeted, predefined damping is realised by the valve device even in the case of failure of the power supply for the coil.

The failsafe spring element can be configured in such a way that it has at least one, preferably a plurality of features, or all the features of the above-described spring element for preloading the armature.

In the case of a second variant, the valve slide interacts via the second valve seat in failsafe operation with the locking element. The second valve seat preferably lies against the locking element in such a way that a throughflow of the damper fluid is blocked or shut off. The locking element is preferably a rigid component. The locking element is preferably formed by a plate. As a result, an uncontrolled throughflow of the damp the fluid is prevented.

In the case of a further embodiment, the valve device has at least one actuating spring which, in failsafe operation, moves the valve slide onto the failsafe spring element or the locking element in such a way that the second valve seat of the valve slide lies against the latter. The actuating spring can be a spiral spring, a helical spring or the like. It is essential that the actuating spring moves that the valve slide in failsafe operation onto the failsafe spring element or the locking element in such a way that they can interact. The actuating spring has firstly the advantage that it brings the valve slide into its failsafe position on the failsafe spring element of the locking element.

Secondly, the actuating spring provides a further spring stiffness and therefore a further spring force which is introduced into the armature in addition to the spring force of the preloaded spring element. The actuating spring preferably has a lower spring stiffness than the preloaded spring element. In other words, the actuating spring is softer than the spring element, with the result that spring forces of different magnitude are introduced in a stroke-dependent manner into the armature when the latter extends for actuation, that is to say displacing of the valve slide. The actuating spring therefore fulfils a dual function.

The armature preferably has at least one longitudinal end for actuating the valve slide, to which longitudinal end the valve slide is connected loosely or fixedly. The loose connection is preferably used in combination with a/the single-step preloading element and the actuating spring. The fixed connection is preferably used in combination with the two-step preloading element. The actuating spring can be dispensed with here, since, in failsafe operation, the spring element retracts the armature and, as a result, moves the valve slide into its failsafe position.

In the case of one embodiment, the valve device comprises at least one valve body, in which the valve slide is guided displaceably in the longitudinal axial direction, and/or at least one housing insert which is received in the housing part, wherein the valve slide is guided displaceably in the longitudinal axial direction in the housing insert, preferably via the armature. Therefore, the valve slide can be guided movably in the longitudinal axial direction in the valve body independently of the armature. In addition or as an alternative, although the valve slide can be arranged displaceably in the valve body, the guidance in the longitudinal axial direction takes place via the armature which is mounted in a longitudinally movable manner in the housing insert. This increases the variability for guiding the valve slide or the armature.

In accordance with a further independent aspect, the invention relates to a vibration damper for a motor vehicle with at least one valve device according to the invention and at least one damper tube, wherein the valve device is connected fluidically or can be connected fluidically to the damper tube.

In accordance with a further independent aspect, the invention relates to a motor vehicle with at least one vibration damper according to the invention.

In accordance with the further independent aspect, the invention relates to a method for producing a valve device, in particular a valve device according to the invention, which comprises at least one valve drive with at least one coil, at least one ferromagnetic armature and at least one housing part, wherein the armature and the housing part have a common longitudinal axis, and the armature can be displaced axially in the housing part in order to actuate a valve slide of the valve device, wherein the valve device has at least one preloading element and at least one spring element, wherein the spring element is supported firstly on the preloading element and is connected secondly to the armature. In the method,
the coil is energized in such a way that the armature is moved in a first longitudinal axial direction into its maximum working position, wherein the coil introduces a magnetic force into the armature, which acts on the first longitudinal axial direction;
the preloading element is fastened in and/or to the housing part in such a way that the spring element applies a spring force counter to the first longitudinal axial direction, wherein the spring force counteracts a magnetic force; and,
during fastening, the preloading element is moved counter to the first longitudinal axial direction until the spring force corresponds substantially to the magnetic force at a predefined current strength.

In the case of one embodiment of the method according to the invention, a further spring force of at least one actuating spring counteracts the magnetic force, wherein the sum of the spring force of the preloaded spring element and the further spring force of the actuating spring corresponds to the magnetic force in the maximum working position of the armature.

In accordance with a further independent aspect, the invention relates to a method for producing a valve device, in particular a valve device according to the invention, which comprises at least one valve drive with at least one coil, at least one ferromagnetic armature and at least one housing part, wherein the armature and the housing part have a common longitudinal axis, and the armature can be displaced axially in the housing part in order to actuate a valve slide of the valve device, wherein the valve device has at least one preloading element, at least one spring element and at least one closing spring, in particular an NC spring, wherein the spring element is supported firstly on the preloading element and is connected secondly to the armature, and wherein the closing spring introduces a closing spring force into the armature, which acts in a first longitudinal axial direction, wherein, in the method,
the coil is energized in such a way that the armature is moved in a second longitudinal axial direction into its maximum working position, wherein the coil introduces a magnetic force into the armature, which acts in the second longitudinal axial direction;
the preloading element is fastened in and/or to the housing part in such a way that the spring element applies a spring force in the second longitudinal axial direction, wherein the spring force and the magnetic force acts in the same direction; and,
during fastening, the preloading element is moved counter to the first longitudinal axial direction until the sum of the spring force of the spring element and the magnetic force corresponds substantially to the closing spring force of the closing spring at a predefined current strength.

In respect of the advantages of the vibration damper, the motor vehicle and the methods, reference is made to the advantages explained in conjunction with the valve device. Moreover, as an alternative or in addition, the vibration damper, the motor vehicle and the methods can have individual features, or a combination of a plurality of features, mentioned previously in relation to the valve device.

The invention will be explained in greater detail in the following text with further details with reference to the appended drawings. The embodiments which are shown are examples of how the vibration damper according to the invention and the valve device according to the invention can be configured.

The same reference signs are used in the following description for identical or identically acting parts.

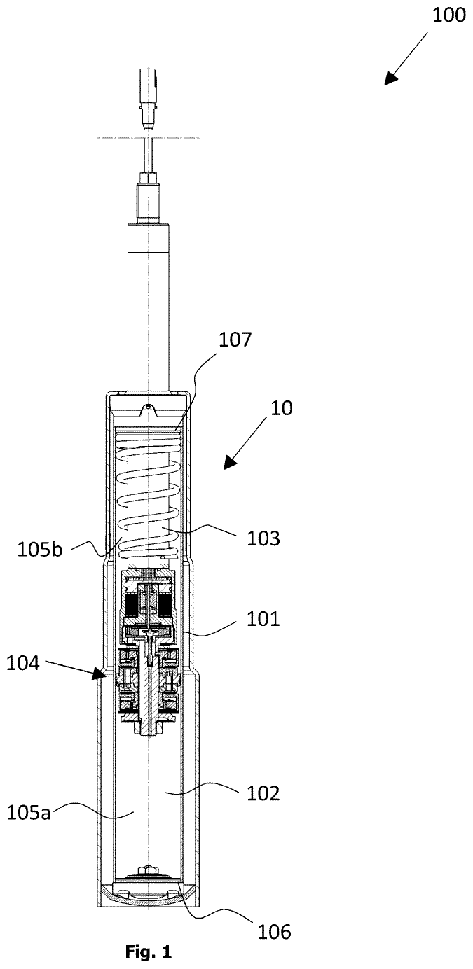

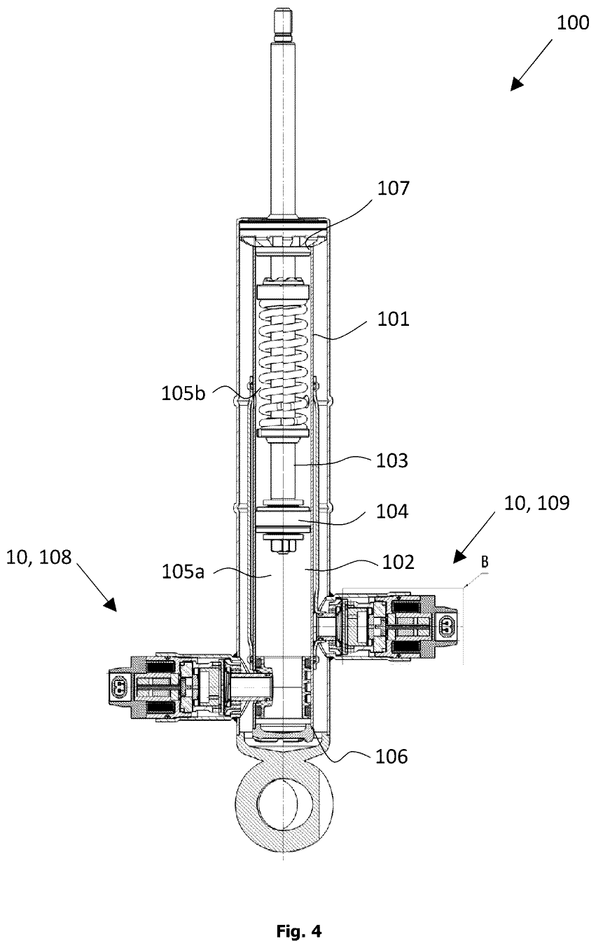

FIGS. 1 and 4 each show a vibration damper 100 in accordance with one preferred exemplary embodiment according to the invention. The vibration dampers 100 according to FIGS. 1 and 4 are configured as twin-tube dampers, wherein the use of the valve device 10 described in the following text is not restricted to twin-tube dampers. The respective vibration damper 100 is preferably used in a motor vehicle.

As shown in FIGS. 1 and 4, the respective vibration damper 100 has a damper tube 101 with a tube interior space 102 which is filled with a damper fluid. The damper fluid is preferably hydraulic oil. It is possible that gas is used as damper fluid as an alternative.

Furthermore, the respective vibration damper 100 has a piston rod 103, on which a working piston 104 is arranged fixedly. The working piston 104 is axially movable in the tube interior space 102. The working piston 104 divides the tube interior space 102 into a first and a second working space 105a, 105b. The first working space 105a is provided at a distance from the piston rod, and the second working space 105b is provided on the piston rod side. In other words, the first working space 105a is formed between a working piston 104 and a longitudinal end 106, remote from the piston rod, of the damper tube 101. The second working space 105b is formed between the working piston 104 and a piston rod-side longitudinal end 107 of the damper tube 101.

The vibration dampers 100 according to FIGS. 1 and 4 each have two damper valves 108, 109. In the case of the vibration damper 100 which is shown in FIG. 1, the two damper valves 108, 109 are arranged so as to adjoin the working piston 104. The damper valves 108, 109 are therefore arranged in an integrated manner in the damper tube 101. Specifically, the damper valves 108, 109 are fastened to the piston rod 103 and, as a result, are axially movable with the working piston 104 in the damper tube 101. In contrast to this, in the case of the vibration damper 100 according to FIG. 4, the damper valves 108, 109 are arranged on the outside, that is to say externally. In general, the damper valves 108, 109 of the two vibration dampers 100 are fluidically connected or can be fluidically connected to the two working spaces 105a, 105b.

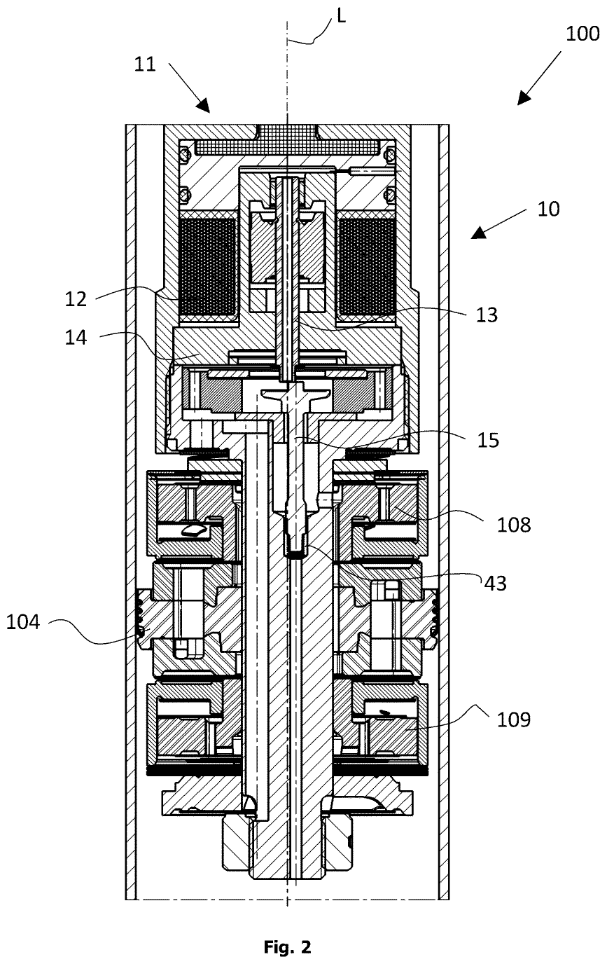

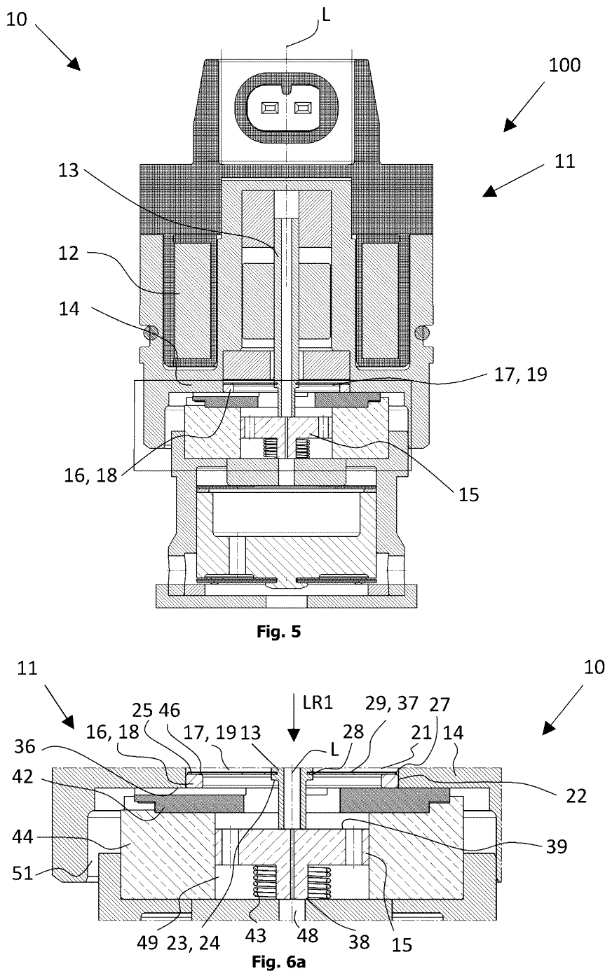

The vibration dampers 100 each have a valve device 10 with a valve drive 11 which comprises a coil 12, a ferromagnetic armature 13 and a housing part 14. In the case of the vibration damper according to FIG. 1, the valve device 10 is fluidically connected or can be fluidically connected to at least one of the damper valves 108, 109. In the case of the vibration damper according to FIG. 4, the valve device 10 is provided per damper valve 108, 109 (cf. FIG. 2). Here, the valve device 10 is combined with the damper valve 108, 109, preferably is formed integrally with it (cf. FIG. 5). The valve device 10 is fluidically connected or can be fluidically connected to the associated damper valve 108, 109. The valve device 10 is a pilot valve.

The coil 12 is provided to actuate the armature 13. The armature 13 is of rod-shaped configuration. The armature 13 and the housing part 14 have a common longitudinal axis L. The armature 13 is arranged axially displaceably in the housing part 14. In other words, the armature 13 is mounted axially displaceably in the housing part 14, wherein the armature 13 is moved in a first longitudinal axial direction LR1 by an energization of the coil 12. The first longitudinal axial direction LR1 corresponds to an extension direction of the armature 13. The armature 13 extends from the housing part 14 when the coil 12, as a result of energization, introduces a magnetic force into the armature 13, with the result that the latter is displaced in the first longitudinal axial direction LR1. The first longitudinal axial direction LR1 can also be called an actuating direction, since, in the case of movement in the first longitudinal axial direction LR1, the armature 13 actuates the valve slide 15 of the valve device 10. The armature 13 interacts with the valve slide 15, in order to realise throughflow control of the damper fluid.

In operation of the respective valve device 10, the coil 14 is loaded with electric current. As a result, a magnetic field is generated, the magnetic field lines of which run substantially in the axial direction in the coil interior and, in particular, in the armature 13. The magnetic flux of the magnetic field runs in a magnetic circuit which is configured within the valve device 10. In accordance with the polarity of the magnetic field, the armature 13 is moved in the axial direction, that is to say in the first longitudinal axial direction LR1. This is to be understood by the introduction of a magnetic force which the coil 12 applies for the axial movement of the armature 13 in the first longitudinal axial direction LR1. As a result of the movement of the armature 13, the valve slide 15 is moved which then regulates throughflow of the damper fluid in interaction with a first valve seat 38 of the valve device 10 and in a manner dependent on a damper fluid pressure which prevails at the valve slide 15.

In the present case, the housing part 14 is a pole tube and is designated as such in the following description.

The valve device 10 of the vibration dampers 100 according to FIGS. 1 and 4 comprises, furthermore, a preloading element 16 which is fastened to the pole tube 14. Furthermore, the valve device 10 has a spring element 17 which is supported on the preloading element 16 and interacts with the armature 13 in such a way that, upon actuation of the armature 13, the spring element 17 applies a spring force counter to a displacement movement, in particular an extension direction, of the armature 13.

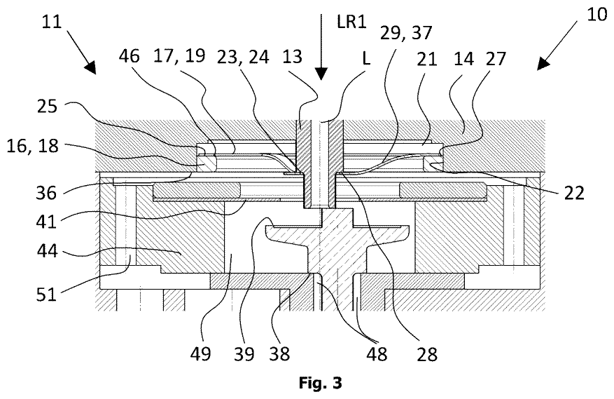

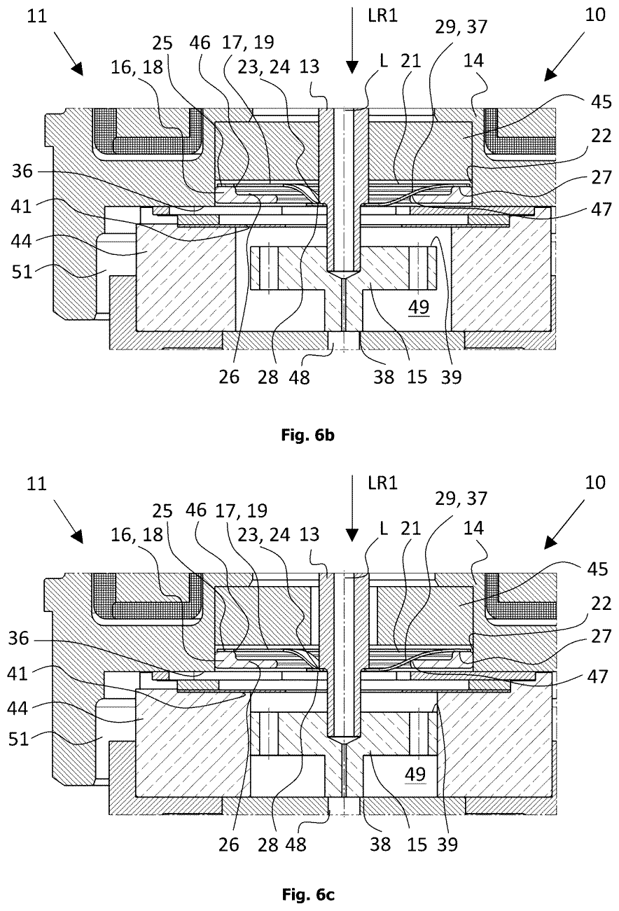

According to FIG. 3 and FIGS. 6a-6c, the respective valve device 10 of the respective vibration damper 100 is shown partially. It can be seen in these figures that the preloading element 16 is of annular configuration. In other words, the preloading element 16 is configured as a ring 18. The preloading element 16 is therefore a preloading ring 18 and is designated as such in the following text. The preloading ring 16 is arranged coaxially with respect to the armature 13. The preloading ring 18 is of rotationally symmetrical configuration. The preloading ring 18 has a first bearing surface 25 which faces the centre of the pole tube 14 in the longitudinal axial direction. The first bearing surface 25 forms a first abutment for the spring element 17.

According to FIGS. 3 and 6a, the preloading ring 18 is of rectangular configuration in cross-sectional profile. The preloading ring 18 is therefore of single-step configuration, wherein its first bearing surface 26 for the spring element 17 forms the only step. In other words, the preloading ring 18 according to FIG. 3 is of single-step configuration.

According to FIGS. 6b and 6c, the preloading ring 18 has a second bearing surface 26 for the spring element 17, which second bearing surface adjoins the first bearing surface 25 radially on the inside. The second bearing surface 26 is arranged offset in the longitudinal axial direction from the first bearing surface 25 in order to form multiple steps. The second bearing surface 26 is configured offset in the longitudinal axial direction which leads away from the centre of the pole tube 14. The two bearing surfaces 25, 26 run in parallel paths around the armature 13. The preloading ring 18 has a cross section with a horizontal L-shape. The second bearing surface 26 has a greater width in the radial direction than the first bearing surface 25. The second bearing surface 26 forms a second abutment for the spring element 17, with which the spring element 17 is in contact in use temporally after the first abutment. As shown in FIGS. 6b and 6c, the preloading ring 18 therefore provides two rolling diameters of different magnitude for the spring element 17. As a result, a stroke-dependent spring stiffness of the spring element 17 can be set. FIG. 3 shows that the preloading ring 18 is of multiple-step configuration.

The preloading ring 18 according to FIGS. 6b and 6c has, as a result of the two-step nature, two edges 46, 47 which are offset from one another, in particular in the radial direction and in the axial direction in relation to the longitudinal axis, and with which the spring element 17 comes into contact sequentially upon movement of the armature 13 in the direction of the valve slide 15, in particular during extension. Upon an actuation of the armature 13, in the case of which the coil 12 introduces a magnetic force into the armature 13 and moves the latter as a result in the actuating direction, in particular extension direction, the spring element 17 is first in contact with the first bearing surface 25 and, in a manner dependent on the armature position, subsequently with the second bearing surface 26 which forms a second abutment for the spring element 17. Or, put another way, the spring element 17 is deformed first of all on the first edge 46 (first rolling diameter) and subsequently on the second edge 47 (second rolling diameter) in the displacement direction of the armature 13 in such a way that the spring element 17 has different spring stiffnesses and therefore introduces spring forces of different magnitude into the armature 13.

According to FIGS. 3 and 6a-6c, a clearance 35 is formed between the armature 13 and the preloading ring 18, into which clearance the spring element 17 can be deformed in the case of a displacement movement of the armature 13 in the first longitudinal axial direction LR1 (extension direction). The clearance 35 is an annular space which surrounds the armature 13 completely.

As can be seen in FIGS. 3 and 6a-6c, the pole tube 14 has a recess 21. The recess 21 is delimited transversely with respect to the longitudinal axis L by its side wall 22. The recess 21 is of cylindrical configuration. Furthermore, the recess 21 comprises a bottom 32 which delimits the recess 21 towards the centre of the pole tube 14. An armature channel 33, in which the armature 13 is arranged axially displaceably, penetrates the bottom 32. The recess 21 is configured coaxially with respect to the armature 13.

In the case of the valve device according to FIG. 3, the armature 13 is guided longitudinally displaceably in the armature channel 33 of the pole tube 14. The pole tube 14 assumes the guidance directly here. In the case of the valve device 10 according to FIG. 6b, a housing insert 45 is provided which is received in the housing part 14. Here, the armature 13 is guided longitudinally displaceably in the housing insert 45. In the case of the valve devices 10 according to FIGS. 6a and 6c, the armature 13 is spaced apart from the housing insert 45 and therefore does not assume a guidance function. In the case of the valve devices 10 according to FIG. 6c, the armature 13 is connected by way of its longitudinal end 34 which faces the valve slide 15 to the valve slide 15 fixedly in terms of displacement.

In the case of the fixed connection in terms of displacement, the longitudinal end 34 of the armature 13 can be connected to the valve slide 15 in a non-positive and/or positively locking and/or integrally joined manner. As shown in FIGS. 6b and 6c, the longitudinal end 34 of the armature 13 can protrude or engage into the valve slide 15 in the axial direction.

It can be seen in FIG. 6c that the valve slide 15 interacts with the side wall of the valve body 44 in such a way that the valve slide 15 and therefore the armature 13 are guided displaceably in the axial direction. Although FIG. 6b likewise, like FIG. 6c, shows a fixed connection in terms of displacement of the longitudinal end 34 of the armature 13 and the valve slide 15, the housing insert 45 assumes the guidance during the axial displacement of the armature 13. The valve slide 15 is spaced apart from the side wall of the valve body 44, with the result that no guidance in the axial direction is realised by it. In the case of the valve devices 10 according to FIGS. 3 and 6a, the respective longitudinal end 34 of the armature 13 lies loosely on the valve slide 15 in the axial direction.

FIGS. 3 and 6a-6c show that the preloading ring 18 is in direct contact radially on the outside with the side wall 22 of the recess 21. The preloading ring 18 is introduced into the recess 21 in such a way that the preloading ring 18 is in pressing contact with the side wall 22. In other words, the preloading ring 18 is pressed into the recess 21. There is therefore a non-positive connection between the preloading ring 18 and the side wall 22, in order to provide a fixed seat of the preloading ring 18. In addition or as an alternative, the preloading ring 18 can be connected to the pole tube 14 in a positively locking and/or integrally joined manner, in order to ensure a fixed seat in the recess 21.

The preloading ring 18 can terminate in a flush manner with a lower side 36 of the pole tube 14 (cf. FIGS. 3 and 6a). As an alternative, the preloading ring 18 can be arranged in a recessed manner in the recess 21, in such a way that the preloading ring 18 is spaced apart from the lower edge 36 (cf. FIGS. 6b and 6c). The preloading ring 18 is introduced into the recess 21 in such a way that a spacing is formed in the longitudinal axial direction between the bottom 32 of the recess 21 and the preloading ring 18.

As is apparent from FIGS. 3 and 6a-6c, furthermore, the armature 13 has a shoulder 23 with a step 24 which is configured so as to face away from the centre of the pole tube 14. The shoulder 23 is configured in the region of the free longitudinal end 34 of the armature 13. In use, as described above, the armature 13 is in contact via the free longitudinal end 34 with the valve slide 15 for actuation purposes.

As is shown in FIGS. 3 and 6a-6c, the spring element 17 is configured as a flat spring. Or, put another way, the spring element 17 is configured as a spring disc. Specifically, the spring element 17 is a flat shaped spring and is designated as such in the following text. FIGS. 3, 6b and 6c show the flat shaped spring 17 in the deformed state, wherein the armature 13 is at its maximum working position which corresponds to the maximum extended state of the armature 13. FIG. 6a likewise shows this by way of example, wherein the flat shaped spring 17 is shown in a straight state, but in reality is deformed like the flat shaped spring is 17 according to FIGS. 3, 6b and 6c.

The flat shaped spring 17 according to FIGS. 3 and 6a-6c is arranged coaxially with respect to the armature 13. The flat shaped spring 17 is arranged between the preloading ring 18 and the bottom 32 of the recess 21. The flat shaped spring 17 lies firstly on the first bearing surface 25 of the preloading ring 18 and secondly on the step 24 of the shoulder 23. The bearing surface of the step 24 and the first bearing surface 25 are oriented in opposed longitudinal axial directions. The same applies to the second bearing surface 26 in the case of the two-step configuration of the preloading ring 18.

The flat shaped spring 17 has a supporting portion 27 for supporting on the preloading ring 18, which supporting portion is arranged radially on the outside in relation to the longitudinal axis L. The supporting portion 27 is in direct contact with the first bearing surface 25. Furthermore, the flat shaped spring 17 has a coupling portion 28 which is arranged radially on the inside in relation to the longitudinal axis L and is connected fixedly to the armature 13 for introducing a spring force. In the present case, the coupling portion 28 is connected to the armature 13 in a non-positive manner.

Specifically, the flat shaped spring 17 lies, in particular loosely, with its coupling portion 28 on the step 24 of the shoulder 23. In addition, the coupling portion 28 can be configured in such a way that informs an armature guide. The armature guide guides the armature 13 upon actuation along the longitudinal axis L.

Furthermore, the flat shaped spring 17 has a connecting portion 29 which connects the coupling portion 28 of the supporting portion 27 in the radial direction. The connecting portion 29 comprises a plurality of webs 37 which run between the supporting and coupling portion 27, 28. The webs 37 are arranged distributed in the circumferential direction, in particular about the armature 13. The webs 37 can run in a rectilinear or curved manner. A combination of both is possible.

In FIGS. 3 and 6a-6c, the armature 13 is situated in its maximum working position. In this position, the coil 12 is loaded with an electric current, and introduces a magnetic force into the armature 13, which magnetic force moves the armature 13 to the maximum working position by displacement in the first longitudinal axial direction LR1. In this state, the armature 13 performs a displacement movement and extends partially out of the pole tube 14. The coupling portion 28 of the flat shaped spring 17 is also moved by the step 24 of the shoulder 23, wherein the supporting portion 27 remains in its position as a result of contact with the first bearing surface of the preloading ring 18.

As a result, the flat shaped spring 17 is deformed resiliently substantially in the region of the connecting portion 29, in particular the webs 37 are deformed resiliently, with the result that a spring force is built up counter to the displacement direction of the armature 13. This spring force acts counter to the displacement movement of the armature 13 and therefore against the magnetic force which is introduced by the coil 12. It is advantageous if, in the starting position of the armature 13, no spring force or only a small spring force is introduced by the flat shaped spring 17 into the armature 13. The magnetic force which is introduced by the magnetic field of the coil is constant over the entire armature/and preferably varies only according to the characteristic (“sport” versus “comfort” or “hard” versus “soft”).

At a low current strength, with which the coil is energized, the spring force of the flat shaped spring 17 is substantially equal to the magnetic force which is introduced by the magnetic field of the coil 12. At an increased current strength, with which the coil 12 is energized, the flat shaped spring 17 serves to adjust the forces to a defined force level. In a maximum working position of the armature 13, the magnetic force can be (much) greater than the spring force of the flat shaped spring 17. Generally, the magnetic force in the maximum working position of the armature 13 can be variable depending on the characteristic. In the maximum working position, the armature 13 is extended completely. The maximum working position preferably corresponds to the maximum stroke of the armature. The maximum working position is preferably determined by the interaction of the armature 13 with the valve slide 15.

In the case of the valve devices 10 according to FIGS. 3 and 6a, the flat shaped spring 17 comprises a spring stiffness as a result of the single-step preloading ring 18. In order therefore for a small spring force to counteract the magnetic force in the starting phase of the extension operation of the armature 13, the respective valve device 10 according to FIGS. 3 and 6a additionally has an actuating spring 43. The actuating spring 43 is oriented in such a way that, upon actuation of the armature 13, it introduces a (further) spring force into the latter counter to its displacement movement in the first longitudinal axial direction LR1. It preferably introduces its spring force over the entire armature stroke. The actuating spring 43 has a spring stiffness which rises in a substantially linear manner with the armature stroke.

The actuating spring 43 is shown in FIG. 6a as a helical spring. Generally, the actuating spring 43 can be a spring which is softer than the flat shaped spring 17. Or, put another way, the actuating spring 43 has a lower spring stiffness than the flat shaped spring 17. It is advantageous if the flat shaped spring 17 introduces its spring force into the armature 13 counter to the first longitudinal axial direction LR1 only from a defined armature stroke. In this case, the magnetic force first acts counter to the spring force of the actuating spring 43 and subsequently counter to the sum of the spring forces of the flat shaped spring 17 and the actuating spring 43. In the maximum working position of the armature 13 which is reached at the maximum stroke of the armature 13, the sum of the spring force of the flat shaped spring 17 and the spring force of the actuating spring 43 corresponds to the introduced magnetic force. Failsafe operation, which will be discussed in greater detail later, can be realised by the actuating spring 43.

In the case of the valve devices 10 according to FIGS. 6b and 6c, the actuating spring 43 is dispensed with, since the preloading ring 18 makes at least two spring stiffnesses of the flat shaped spring 17 possible as a result of its two-step configuration. With a continuing stroke, in particular extension, of the armature 13, the flat shaped spring 17 comes into contact with the second bearing surface 26 of the preloading spring 18 after the first bearing surface 25. Specifically, with a continuing stroke, in particular extension, of the armature 13, the flat shaped spring 17 comes into contact, after the first edge 46 which is arranged radially on the inside on the first bearing surface 25, with the second edge 47 of the preloading ring 18 which is arranged radially on the inside on the second bearing surface 26. As a result, the flat shaped spring 17 has two different spring stiffnesses, with the result that different spring forces can be introduced into the armature 13 in a manner dependent on the stroke. In the maximum working position of the armature 13 which is reached at the maximum stroke of the armature 13, only the spring force of the flat shaped spring 17 corresponds here to the introduced magnetic force. In the case of these exemplary embodiments, the flat shaped spring 17 fulfils a dual function.

The valve devices 10 according to FIGS. 3 and 6a-6c comprise two valve seats 38, 39. The first valve seat 38 adjoins a throughflow opening 48 for the damper fluid, which leads into a working space 49 of the valve body 44. The valve slide 15 is received axially displaceably in the working space 49. The second valve seat 39 is configured on the valve slide 15 so as to face the armature 13 in an axial direction.

In normal operation, the valve slide 15 interacts with the first valve seat 38, in order to regulate a throughflow of damper fluid. In normal operation, the coil 12 is energized, with the result that it introduces a magnetic force into the armature 13, which then in turn presses the valve slide 15 against the first valve seat 38. In a manner dependent on a damper fluid pressure in the throughflow opening 48 prevailing at the valve slide 15, the valve slide 15 and thus also the armature 13 are moved counter to its actuating direction, that is to say in the retraction direction. As a result, a throughflow cross section for the damper fluid and therefore defined damping is set between the first valve seat 38 and the valve slide 15 in a manner dependent on the fluid pressure.

Furthermore, the valve devices 10 according to FIGS. 3, 6b and 6c have a failsafe spring element 41 which is arranged in the longitudinal axial direction between the valve slide 15 and the preloading ring 18. The failsafe spring element 41 is configured as a flat spring. Specifically, the failsafe spring element 41 is configured as a spring disc. In normal operation, the second valve seat 39 of the valve slide 15 is spaced apart from the failsafe spring element 41 in such a way that a free passage for the damper fluid from the working space 49 into a throughflow channel 51 is formed.

In failsafe operation, the failsafe spring element 41 interacts with the second valve seat 39. The coil 12 is currentless in failsafe operation. This can take place deliberately or as a result of a defect, that is to say in an undesired manner. In failsafe operation, the armature 13 is free from magnetic force. The case can therefore occur in normal operation that the power supply of the coil 12 fails. In this state, the armature 13 moves back into its starting position, in which no interaction with the valve slide 15 for actuating the slide is possible.

According to FIG. 3, the valve slide 15 is then displaced in the axial direction by the above-described actuating spring 43 until the second valve seat 39 lies against the failsafe spring element 41. The actuating spring 43 can be seen in FIG. 2. The failsafe element 41 is deformed resiliently in a manner dependent on a damper fluid pressure prevailing at the failsafe spring element 41. As a result, a throughflow cross section for the damper fluid is set between the failsafe spring element 41 and the second valve seat 39 of the valve slide 15 in a manner dependent on the fluid pressure. Defined damping is thus realised by the valve device 10 even in the case of failure of the power supply for the coil 12.

According to FIG. 6a, a locking element 42 is arranged instead of the failsafe spring element 41. The locking element 42 is plate-shaped. Furthermore, the actuating spring 43 is arranged in the working space 49 on the valve slide 15. As in the case of the valve device 10 according to FIG. 3, the valve slide 15 is moved with its second valve seat 39 in the currentless state of the coil 12, namely onto the locking element 42 here. The locking element 42 is of rigid configuration. In the case of this variant, in failsafe operation, the throughflow of the damper fluid is blocked by the second valve seat 39 lying tightly against the locking element 42. Damping is thus generally prevented in the case of failure of the power supply for the coil 12.

As described above, in the case of the valve device 10 according to FIGS. 6b and 6c, the actuating spring 43 is dispensed with. As a result of the fixed connection of the armature 13 and the valve slide 15 in terms of displacement, the valve slide 15 is moved with the armature 13 into its starting position in the case of failure of the power supply of the coil 12. This takes place substantially by the flat shaped spring 17. Since, in failsafe operation, the flat shaped spring 17 retracts the armature 13, the valve slide 15 is moved into its failsafe position. Here, the valve slide 15 is displaced in the axial direction until the second valve seat 39 lies against the failsafe spring element 41. In a manner dependent on a damper fluid pressure which prevails at the failsafe spring element 41, the failsafe spring element 41 is deformed resiliently. As a result, a throughflow cross section for the damper fluid is set between the failsafe spring element 41 and the second valve seat 39 of the valve slide 15 in a manner dependent on the fluid pressure.

Defined damping is thus realised by the valve device 10 even in the case of failure of the power supply for the coil 12.

It is noted at this point that the features of the above-described exemplary embodiments can be combined freely among one another.

### LIST OF REFERENCE SIGNS

10 Valve device
11 Valve drive
12 Coil
13 Armature
14 Housing part
15 Valve slide
16 Preloading element
17 Spring element
18 Ring
19 Flat shaped spring
21 Recess
22 Side wall
23 Shoulder
24 Step
25 First bearing surface
26 Second bearing surface
27 Supporting portion
28 Coupling portion
29 Connecting portion
31 Flow passage
32 Bottom
33 Armature channel
34 Longitudinal end
35 Clearance
36 Lower edge
37 Web
38 First valve seat
39 Second valve seat
41 Failsafe spring element
42 Locking element
43 Actuating spring
44 Valve body
45 Housing insert
46 First edge
47 Second edge
48 Throughflow opening
49 Working space
51 Throughflow channel
100 Vibration damper
101 Damper tube
102 Tube interior space
103 Piston rod
104 Working piston
105a First working space
105b Second working space
106 Longitudinal end remote from the piston rod
107 Piston rod-side longitudinal end
L Longitudinal axis
LR1 First longitudinal axial direction

1. A valve device for a vibration damper, comprising:
at least one valve drive including:
at least one coil;
at least one ferromagnetic armature which can be actuated by the coil; and
at least one housing part including a pole tube;
wherein the armature and the housing part have a common longitudinal axis, and the armature is arranged axially displaceably in the housing part;
wherein the armature is adapted to interact with a valve slide of the valve device for throughflow control and/or for pressure control of a damper fluid;
wherein the valve device has at least one preloading element which is fastened in and/or to the housing part, and comprises at least one spring element which is supported on the preloading element and interacts with the armature in such a way that, upon actuation of the armature, the spring element applies a spring force counter to a displacement direction of the armature or in a displacement direction of the armature.

2. The valve device according to claim 1, wherein the preloading element is configured as a ring, and/or the spring element comprises at least one flat spring, in particular a flat shaped spring, wherein the preloading element and/or the spring element are/is arranged coaxially with the armature.

3. The valve device according to claim 1, wherein the housing part has at least one recess, in which the preloading element and the spring element are received, wherein the preloading element is connected fixedly to a side wall of the recess, in particular by being pressed in.

4. The valve device according to claim 3, wherein the preloading element is connected to the side wall of the recess in a non-positive and/or positively locking and/or integrally joined manner.

5. The valve device according to claim 1, wherein the armature has at least one shoulder with a step which faces away from a centre of the housing part in the longitudinal axial direction, wherein the spring element lies at least partially on the step.

6. The valve device according to claim 1, wherein the preloading element has at least one first bearing surface which faces a centre of the housing part in the longitudinal axial direction and forms a first abutment for the spring element.

7. The valve device according to claim 6, wherein the preloading element has a second bearing surface for the spring element, which adjoins the first bearing surface radially on the inside and is offset in the longitudinal axial direction from the first bearing surface in order to form the step.

8. The valve device according to claim 7, wherein the spring element has at least one supporting portion for supporting on the preloading element, which supporting portion is arranged radially on the outside in relation to the longitudinal axis, wherein the supporting portion is preferably in contact with the first bearing surface.

9. The valve device according to claim 8, wherein the spring element has at least one coupling portion which is arranged radially on the inside in relation to the longitudinal axis and is connected to the armature for the introduction of a spring force.

10. The valve device according to claim 9, wherein the spring element has at least one connecting portion which connects the coupling portion to the supporting portion, wherein the connecting portion comprises at least one web, in particular a plurality of webs, which extends/extend in the radial direction between the coupling portion and the supporting portion.

11. The valve device according to claim 10, wherein the spring element comprises at least one armature guide which guides the armature along the longitudinal axis, wherein the armature guide is preferably part of the coupling portion.

12. The valve device according to claim 1, wherein at least one closing spring, in particular an NC spring, which moves the armature and/or a/the valve slide of the valve device in a currentless state of the coil into a closed position, wherein, in an energized state of the coil, the magnetic force and the spring force of the spring element act counter to a closing spring force of the closing spring.

13. The valve device according to claim 1, wherein at least two valve seats and at least one failsafe spring element and/or at least one locking element, wherein the failsafe spring element or the locking element is arranged in the longitudinal axial direction between the valve slide and the preloading element, wherein, in normal operation, the valve slide interacts with the first valve seat and, in failsafe operation, the failsafe spring element or the locking element interacts with the second valve seat which is configured on the valve slide.

14. The valve device according to claim 13, further comprising at least one actuating spring which, in the failsafe operation, moves the valve slide on to the failsafe spring element or the locking element in such a way that the second valve seat of the valve slide lies against the latter.

15. The valve device according to claim 1, wherein the armature has at least one longitudinal end for actuating the valve slide, to which longitudinal end the valve slide is connected loosely or fixedly.

16. The valve device according to claim 1, further comprising at least one valve body, in which the valve slide is guided displaceably in the longitudinal axial direction, and/or at least one housing insert which is received in the housing part, wherein the valve slide is guided displaceably in the longitudinal axial direction in the housing insert, preferably via the armature.

17. The valve device according to claim 1, wherein the valve device is incorporated within a vibration damper for a motor vehicle, the vibration damper further including at least one damper tube, wherein the valve device is connected fluidically or can be connected fluidically to the damper tube.

18. A method for producing a valve device including at least one valve drive with at least one coil, at least one ferromagnetic armature and at least one housing part, wherein the armature and the housing part have a common longitudinal axis, and the armature can be displaced axially in the housing part in order to actuate a valve slide of the valve device, wherein the valve device has at least one preloading element and at least one spring element, wherein the spring element is supported firstly on the preloading element and is connected secondly to the armature, wherein the method comprises:
energizing the coil in such a way that the armature is moved in a first longitudinal axial direction into its maximum working position, wherein the coil introduces a magnetic force into the armature, which acts in the first longitudinal axial direction;
fastening the preloading element in and/or to the housing part in such a way that the spring element applies a spring force counter to the first longitudinal axial direction, wherein the spring force counteracts the magnetic force; and
during fastening, moving the preloading element counter to the first longitudinal axial direction until the spring force corresponds substantially to the magnetic force at a predefined current strength.

19. The method according to claim 18, wherein a further spring force of at least one actuating spring counteracts the magnetic force, wherein the sum of the spring force of the preloaded spring element and the further spring force of the actuating spring corresponds to the magnetic force in the maximum working position of the armature.

20. A method for producing a valve device including at least one valve drive with at least one coil, at least one ferromagnetic armature and at least one housing part, wherein the armature and the housing part have a common longitudinal axis, and the armature can be displaced axially in the housing part in order to actuate a valve slide of the valve device, wherein the valve device has at least one preloading element, at least one spring element and at least one closing spring, including an NC spring, wherein the spring element is supported firstly on the preloading element and is connected secondly to the armature, and wherein the closing spring introduces a closing spring force into the armature, which acts in a first longitudinal axial direction, wherein the method comprises:
energizing the coil in such a way that the armature is moved in a second longitudinal axial direction into its maximum working position, wherein the coil introduces a magnetic force into the armature, which acts in the second longitudinal axial direction;
fastening the preloading element in and/or to the housing part in such a way that the spring element applies a spring force in the second longitudinal axial direction, wherein the spring force and the magnetic force act in the same direction; and
during fastening, moving the preloading element counter to the first longitudinal axial direction until the sum of the spring force of the spring element and the magnetic force corresponds substantially to the closing spring force of the closing spring at a predefined current strength.
